(19) United States
(12) Patent Application Publication
(10) Pub. No.: US 2011/0125844 A1
(43) Pub. Date: May 26, 2011

(54) MOBILE ENABLED SOCIAL NETWORKING APPLICATION TO SUPPORT CLOSED, MODERATED GROUP INTERACTIONS FOR PURPOSE OF FACILITATING THERAPEUTIC CARE

(75) Inventors: George H. Collier, Califon, NJ (US); Josephine Micallef, Maplewood, NJ (US)

(73) Assignee: TELCORDIA TECHNOLOGIES, INC., Piscataway, NJ (US)

(21) Appl. No.: 12/780,203

(22) Filed: May 14, 2010

Related U.S. Application Data
(60) Provisional application No. 61/179,186, filed on May 18, 2009.

(51) Int. Cl. G06F 15/16

(52) U.S. Cl. 709/204

(57) ABSTRACT

A computer readable medium stores a program executable on a computing device, the program comprising data and instructions for providing an interface for users to create and display a user profile and enabling the users to safely and securely transmit and receive communications and other data to and from other individuals in the network for the purposes of communication to enhance the social resources of users under medical care. Moreover, the system provides a means for data from the user's devices and other connected devices to be collected, combined with the communication data and analyzed for medical purposes. Moreover, the program provides for storing at a storage unit a first set of predefined criteria for indicating medical need, and analyzing the data transmitted by a device at a processor in comparison to the first set of predefined criteria to determine if the user exhibits medical need. Accordingly, information may be transmitted to the users, or to other users, including medical care givers, based on the analysis. Such medical care givers may interact with users exhibiting medical need and transmit a variety of educational and training material for purposes of medical treatment.

### CROSS-REFERENCE TO RELATED APPLICATIONS

This application claims the benefit of the filing date of U.S. Provisional Patent Application No. 61/179,186 filed May 18, 2009, the disclosure of which is hereby incorporated herein by reference.

### BACKGROUND OF THE INVENTION

Presently, social network services are used to connect individuals through electronically linked computers and mobile devices. The individuals may share interests and/or activities, and motivated by this come together to form an online community.

Early social networking websites took the form of a variety of computer supported online communities, where individuals interacted through bulletin board systems, email “exploders” and instant messaging. A famous early form of these communities were the Internet based Usenet discussion groups, such as The WELL (www.thewell.com).

As the technology of the Internet rapidly advanced, people's personal websites evolved towards diaries. As a result the Internet “meme” of keeping a “web log” or “blog” was established. Building on the success of blogging another important step was taken with micro-blogging (most famously Twitter®) which reduced the entries to small “bites” of 140 characters or less and increased the frequency of posting, creating the “micro-blog”.

Social networking sites, led by pioneers such as Facebook® and Myspace® and many others have now grown to the point where they not only allow a user to create a rich online presence, they have become to act as Internet “switching points” serving as online content and media aggregators and rising to become among the most popular online destinations.

Instant messaging and “texting” remain extremely popular and many of today's teens have moved away from Facebook and similar sites to carry out more of their electronic social interactions through these media than through the online social networking sites.

Many social networking systems provide a “lifestream”, a time-ordered stream of documents that functions as a diary of an electronic life. Building on this concept, “social activity streams” are now a prominent feature of many social network services. Services such as Facebook weave together status updates, uploaded photos, user selected URLs, etc. into an ongoing temporally ordered view of a user's life which is shared with her friends and followers.

Another feature in current social networking is the ability to find other users to add to their network. Facebook, for instance, provides a number of mechanisms which help users expand and manage their social networks. Many of these are based on leveraging the social relationship graph among users, e.g., Facebook would suggest as “friends” people who have a lot of friends in common with you. User profiles are used to help users find other members who had similar interests based on aspects of other users' profiles

Mobility, in the form of cell phones, PDAs, net books and other small, portable computing devices, introduces a new dimension to social networking technology. Friends are something we like to “bring along with us” and the mobile device helps to deliver on that promise. Originally, the mobile phone was simply a wirelessly connected phone handset that we could take with us. In contrast, today's smartphones are small computers with a wide array of interfacing and multi-media capabilities and are increasingly used to deliver social networking capabilities.

In summary, the primary function of social networking services are 1) to provide mechanisms for users to socially interact with each other through a variety of media, and 2) to provide mechanisms to facilitate the social interaction including supporting conversational and diary styles of communication, providing a “lifestream” of events, integrating a variety of media for the purpose of communication, integrating a variety of communication modalities and finding other users with which one could bond.

Social network services can provide public facilities for extensive networks of users, for example Facebook has millions of concurrent users. Other implementations of social networking are focused on specialized groups of people. For example, LinkedIn®, specializes in business connections. On an even smaller scale, specialized “closed” social networking applications have been developed to support a corporation or other institutions only.

For this perspective, implementations of social networking can be broken down into two broad categories: closed, special purpose social networking services and open general purpose social networking services—based on the type of user community the social networking system draws on and the goals of the managers of the social networking system. A closed service is a closed/private community which might consist of a group of people within a company, association, society, education provider or organization. Such sites are often created and managed by associated organizations from whom the members are drawn. An open service is freely open to the public and available to all web users, is designed to attract new users and is often supported by advertising and other mechanisms.

However, whether open or closed there is commonality across the functionality typically provided by social networking sites. Users can upload a picture of themselves, create a “profile” and create and maintain social connections with other users. Management of the social relations can be done by users or site managers or a combination of the two. Confirmed social connections can have variable strengths and users can vary the amount of information they expose to others depending on the “strength” of the connection.

As mentioned above, mobile social networking has become popular. Popular social networking sites supply applications for smartphones and even support interaction through simpler mechanisms such as SMS (Short Messaging System) messaging or mobile email. As the popularity of the cameras integrated into mobile devices has increased, social networking sites have expanded to provide facilities for hosting pictures and videos taken with cell phones. Mobile phone users can now edit their profiles, confirm friends, create and participate in chat rooms, hold private conversations, share photos and videos, and blog—all using their mobile phone.

Location aware social networking integrates geospatial data and visualization to organize user participation around geographic features and their attributes. For example,. Foursquare allows users to check in at locations and win virtual badges and awards based on the activities they perform at the locations they visit.

Social networks are also being used by teachers and students as a communication tool. Because many students are already using a wide-range of social networking tools, teachers have become familiar with the technology and are using it to their advantage. Teachers and professors are doing everything from creating chat-room forums and groups to extend classroom discussion to posting assignments, tests and quizzes, to assisting with homework outside of the classroom setting. For example, the open source social networking software Elgg has been used by a number of Universities who wish to provide their students with a closed and protected social networking environment.

Despite the known uses and types of social networking services described above, there are many new beneficial applications which could be supported by new methods and systems for social networking which have yet to be developed. In particular, the method and system described in this invention is focused on increasing the social resources of a person under medical treatment. Such an application demands specialized methods and systems to support social networking. Many recent studies have demonstrated the value of such an application. For example, while, it has intuitively been known for some time that loneliness is “bad for you”, a recent study has demonstrated that chronic loneliness has as large an impact on physical health as smoking, obesity or lack of exercise. People with rich personal networks recover more quickly from disease and live longer. They recover faster from heart attacks and live longer. They are even less likely to get the common cold. And these are just the effects on physical health. Lack of social resources correlates with depression, suicide and emotional distress. For example, a recent program providing phone based support to returning New Jersey war veterans has substantially cut the suicide rate.

Accordingly, a web and mobile based social network method and supporting system which focuses patients under medical care is needed. While specialized networks and systems exist for care givers such as doctors (e.g., Sermo.com), a system which focuses on features, capabilities and mechanisms of a mobile enabled social networking system appropriate to people under long term medical treatment such as survivors of catastrophic illnesses or trauma does not exist.

Herein described is a system and method to provide a specialized form of mobile centric social networking for those under medical care where the guiding requirements are that the communication be private, safe and secure, address the medical requirements of patients and care givers and leverages the capabilities that a mobile computing device, such as a smartphone, provides.

### BRIEF SUMMARY OF THE INVENTION

The focus of this invention is a method and system to securely and safely provide mobile enabled social support network to individuals in a community under medical care and increase their access to social resources, including peers, lay and professional care givers where the primary participant interface is a mobile device. However, as conceived, end user stationary computers may also be part of this system. The system also may encompass connected sensor devices (e.g., a Bluetooth connected glucometer) which could potentially provide data to the system. These devices may be directly connected to the system, or be connected through an end user device (e.g., mobile phone or desktop computer).

In the context of this invention, a care giver can be medically trained professional (e.g., nurse) or a lay care giver, such as a family member (e.g., brother) or other lay person (e.g., mentor) that has been trained or has important experiences which make them fit to deliver medically significant care and social support. While the focus of the invention is care delivered through the social networking system itself (e.g., conversational support) interactions with the system may also lead to physical care (e.g., prescription of a psychotropic drug) or referral to other medically valuable resources outside of the system.

According to an aspect of the invention care givers may have access to a variety of analyses and presentations of data about the user. These analyses may be based on communication within the system and other data collected and delivered by an end-user mobile computing device such as the geographic locations they have visited or physiological indicators. These analyses may be made available through a standard web browser. The ability to configure and manage the system may also be available through a web browser. An interface may be provided to make users part of the social network, and users may transmit and receive data to and from other individuals associated with the network, utilizing both mobile computing devices and stationary computing devices for a variety of health related purposes including, but not limited to communication and social interaction, advice giving, mentoring, educational outreach, job coaching, morale boosting, event notifications, reminders, rewards, praise and community integration. Additionally sensors on a mobile device including, but not limited to, GPS and accelerometer readings, may be utilized to capture data and this data may be transmitted to central Internet connected servers for management, storage and analysis. Data from connected devices, particularly sensors of various types, e.g., Bluetooth glucometers, may also be collected, integrated with the social data and made available through the network to medical care givers in support of facilitating the care of the patient. The mobile portion of the system may be connected to these servers by a variety of data transmission networks (including, but not limited to, wireless services such as cellular, WiFi, WIMAX, and wired connections such as Ethernet WANs) to the central computing resources which may execute computer algorithms to store, manage and analyze the data from the mobile and stationary end-user portion of the system.

The central server portion of the system may computationally “fuse” the data from the end user (mobile and fixed) portion of the system with other data from a variety of sources to form a “common operating picture” of the user. For example, it may combine information from geospatial databases, either entered by the users of the system (e.g., “my house”) or obtained from other databases, e.g., Yahoo!® Local, with data from GPS sensing to categorize the type of location of a user (e.g., work, church, firehouse, and restaurant). Both the current operating picture of a user and overall trends in this operating picture (such as the percentage of time spent in different locations) may be provided to health care givers via web based presentation for the purposes of improving the care given to the users. This is but one example of the feedback the system will provide to care givers.

As knowing that one has social resources to call upon has been scientifically shown to be important to the rehabilitation of survivors, the central server may take advantage of data received from connected end devices to determine “presence” of other users or care-givers. This presence information about members of one's social and care giving network may be made available to users, as appropriate, to provide social and psychological support. Additionally, the system may facilitate the process for contacting a user who is present via network service provider based voice calling or other means.

The central server may also be utilized to provide a history or time-line of a user's communications (also called “posts”) which is accessible to other users of the system to encourage both the conversational and the blogging style of interaction described above. The system may provide a mechanism to route messages to another group of users, a particular group of users or simply to a time-line for purposes of blogging and sharing status with other users.

The system may provide a variety of computer algorithms to analyze the communication and sensor data from the mobile portion of the system for three major purposes: a) to facilitate the social interactions between users, b) to provide insight to care givers on the social, emotional and behavioral status of the users of the system for the purpose of providing healthcare and c) to provide for automated warnings and interventions based on analysis of the stored communication and sensor data. This feature facilitates weaving the social fabric between users and care givers. The communication data, as well as the sensor data gathered from the mobile device, such as spatial location, may be stored in at least one and possibly more cooperating storage units, and the resulting data collected by the system may be analyzed via algorithms by at least one and possibly more cooperating processors for the purposes described above.

Additionally the storage and processing unit(s) may be utilized to support the administrative capabilities of the system. These administrative capabilities include the ability to configure and maintain the computing and mobile infrastructure (e.g., adding a user's device to the network); managing the social network itself (e.g., adding a user to a group; giving someone special privileges to oversee the interactions in a social networking group); and administration of the detailed interactions within a group (e.g., striking an inappropriate communication).

To ensure privacy, as appropriate the system may provide mechanisms to secure the communications and data transmissions such as encrypting data during transmission, securing access to the device with single or multi-factor authentication systems, provide a “remote wipe” capability, restricting communication within the system to only trusted devices and applications and other similar state-of-the art means for ensuring the privacy and security of network communication systems.

The system may provide on-going analysis of the communication and sensor data from the mobile portion of the network. This analysis may be used to provide feedback to care givers on user progress or to help guide intervention when needed. For example, a determination may be made at the processor that the user exhibits emotional or psychological problems. As a result a care giver could be alerted through their mobile device or over the web interface that intervention is necessary. In turn, therapy may be provided to the user, for example, from a mental health professional (either within the system or outside of it), or a request may be transmitted to other individuals to communicate with the user.

User interactions with the system as well as automatically collected data may be stored and made available for analysis. This data may be analyzed using system supplied computer algorithms to assess user progress and to detect problems as well as to provide automated feedback and cues to the user.

According to one aspect of the invention, which distinguishes it from open social networking systems, is its “safety”. The clients should be able to participate in the system without fear of being subjected to abuse by other users. To this end, the system in this realization may provide automated computer based analysis of the content of the communications as well provide mechanisms for care givers such as lay mentors and professional case managers to oversee the tone of the communications. If communications take an inappropriate turn, the system may provide mechanisms to strike the communications from the visible record and to warn the offending users. Additionally the system will allow care givers to manage the groups, adding, removing or suspending users as appropriate, to keep the communications civil and functional from a medical perspective.

Another aspect of the invention provides a system for providing support to individuals in a community. The system may include a server configured to communicate with at least one user client mobile device and at least one central server and administrative computer, a storage medium storing the history of the communications, the mobile sensor data and medically relevant analyses which can be applied to the communication and mobile derived data and at least one processor configured to perform these analyses and the ability to communicate with at least one connected mobile device or computer the results of these analyses. The storage medium may further store user history data related to analyses performed by the processor. Accordingly, the processor may be configured to analyze the user history data in connection with analyzing information communicated through the at least one user client computer in connection with medically relevant algorithms and related stored data.

The system may further include a unit for enabling data in a first format to be converted to data of a second format for transmission between different types of devices, and a unit for organizing communications to and from at least one user mobile device and the central server. The communications may be organized by time of transmission, time of receipt, sender, recipient, or subject matter.

According to yet another aspect of the invention, a computer readable medium stores a program executable on a computing device, the program comprising data and instructions for providing an interface for users to create and display a user profile and enabling the users to transmit and receive communication data to and from other individuals. This interface may be provided on both mobile and stationary computing devices. These devices may be connected by a variety of data transmissions technology including both wireless and wired.

Moreover, the storage medium may store multiple sets of predefined criterion for indicating medically important sensor data, events, communication data and data patterns, and the processor may be further configured to analyze information communicated by at least one user mobile device or client computer in connection with of the stored algorithms and related data.

Moreover, the processors may have the capability for rapidly analyzing events, communications and patterns in comparison to the multiple set of predefined criteria to determine if there is an opportune moment to intervene with the user or to alert another such as a care giver. Accordingly, information may be transmitted or interaction initiated with the user based on the analysis.

### BRIEF DESCRIPTION OF THE DRAWINGS

FIG. 1 illustrates a system diagram of a social networking system according to an aspect of the invention.

FIG. 2 illustrates a flow diagram of a method according to an aspect of the invention.

FIG. 3 illustrates a schematic diagram of a system architecture according to an aspect of the invention.

FIG. 4 is a screenshot of a user interface according to an aspect of the invention.

### DETAILED DESCRIPTION

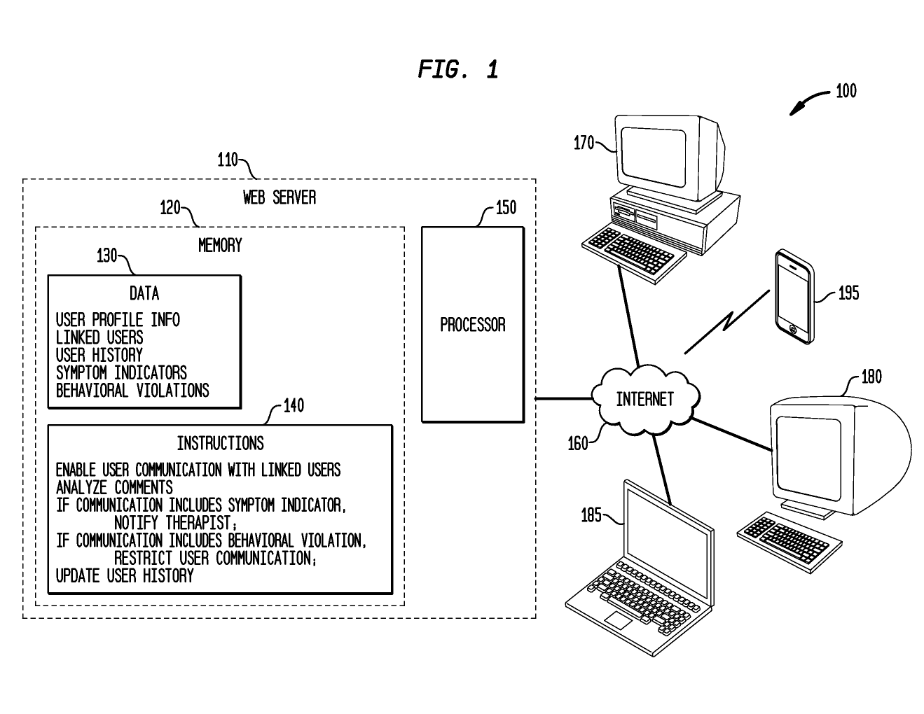

A closed, safe and secure social network as described herein may be used to provide guidance, support, and therapy to members of a community for medical purposes. For example, members of the armed forces with traumatic brain injury, their family, friends, and medical care team may join a social network designed to facilitate communication and improve the soldiers' ability to handle cognitive or emotional difficulties. FIG. 1 describes a system which may be utilized by such a community.

As shown in FIG. 1, a system 100 in accordance with one embodiment of the invention comprises a web server 110, including a processor 150, and a network of computers such as end-user devices 170-185 that communicate with the server 110 via Internet 160. It should be understood that communication between end user devices 170-185 and server 110 may alternatively or additionally occur through a variety of data transmission mechanisms including wireless networks, such as telecommunication carrier networks, WiFi, etc. and wired data transmission protocols such as Ethernet. Generally, end-user devices 170-185 may comprise any type of computer including a laptop or desktop computer, cell or smart phone, personal digital assistant or workstation. Generically, as used herein, a computer encompasses any machine that manipulates data according to a set of instructions. Communication with the server may include transmitting data from the end-user devices or personal computers 170-185 to the server 110 to create or update user profiles, or to be delivered to another end-user personal computer (e.g., Short Message Service (SMS) text, email, web post, etc.).

According to an aspect of the invention, users of end-user devices or personal computers 170-185 may have experienced a trauma or life threatening illness and are under medical care. The medical care givers that are responsible for organizing the system may choose provide access to the social network and form groups for discussion and sharing of select information to increase the social resources of the survivors. Further the care givers may encourage certain users to become mentors to other users. Additionally the medical care givers may encourage friends and family members to join the network as appropriate. Following this example, some of the information communicated with the server 110 and among the end-user devices or personal computers 170-185 may be related to common important life experiences (e.g., military service) or common medical issues (e.g., traumatic injury). For example, users may discuss a current military-related event or aspects of their treatment. Lay care givers may discuss (in a separate group) some of the challenges of caring for the survivors.

According to one aspect of the invention the communication data may be leveraged for a number of purposes such as social interaction, advice giving, mentoring, educational outreach, morale boosting messages, event notifications, reminders, rewards and praise and community reintegration. For example, the invention may support educational outreach through informational messages and quizzes delivered to the end-user computers 170-185. For a further example, a user may be awarded with virtual rewards, such as badges, titles, and levels, for positive social interaction with other users.

According to another aspect of the invention, mobile related capabilities of end-user devices 170-185 may be utilized to gather further information about the user, subject to the user's approval. For example, mobile device 175 may provide information regarding the user's location. This data collected from the mobile end-user device 175 may be transmitted to the server 110 where it may be stored in memory 120 or other storage media for analysis. It may be combined with the communication data or data from other sources to provide detailed information for assessing a user and determining whether intervention by a care giver is necessary.

According to one aspect of the invention, the composition and management of a group that is communicating within the network may impact the effectiveness of medical assistance offered to users within the group. For example, the server 110 may store an application including one or more mechanisms whereby a care giver can construct a group by entering data into the memory 120, and may configure the routing of communications within a group to best serve that particular group or particular users within the group (e.g., a message to the whole group is delivered to each user's device and the users are notified of the arrival of that message data and a message to a particular user is routed to only that end-user). Membership in a communication group may be under the control of another user with special privileges, e.g., a medical care giver or a system administrator. According to one aspect, one or more of the end-user devices or personal computers 170-185 may be an administrative client. For example, as mentioned above and explained in greater detail herein, the administrative client may possess additional access rights as compared to a user, and may exercise some control over the users.

Although only a few devices and computers are depicted in FIG. 1, in accordance with other aspects of the present invention the system 100 may include a large number of connected computers and mobile communication devices. Preferably, end-user devices or computers 170-185 are mobile devices which supply voice and text based communication, have a high speed wireless data connection, supply display and data entry mechanisms sufficient to supporting the social networking application. Typical desktop or netbook computers may also be supported by the system as they supply interfaces for end users to interact with the system.

In addition the mobile devices and end-user computers 170-185 may comprise any device or client device capable of processing instructions and transmitting data to and from humans and other computers, including network computers lacking local storage capability, PDA's with modems and Internet-capable wireless phones. Although the input means shown in FIG. 1 is the keyboard, the system also encompasses other means for inputting information from a human into a computer, such as a mouse, a microphone, a touch-sensitive screen, voice commands, etc.

End-user mobile devices or computers 170-185 may communicate with a data transmission network 160 via a variety of data transmission technologies including wireless data and wired data transmission currently available today or forthcoming in the future. This transmission can utilize the services of a communication provider such as a communications carrier, or an Internet services provider or any other suitable mechanism for providing the requisite data transmission between the end-user devices 170-185.

Server 110 contains hardware for sending and receiving information over a wide area data network including the Internet such as web pages, files or other data formats suitable to providing the functions of this system. The server 110 may be a typical web server or any computer network server or other automated system capable of communicating with other computers and mobile devices over a network. In accordance with one embodiment of the invention, the server 110 comprises a computer containing a processor 150, memory 120 and other components typically present in general purpose computers.

Memory 120 stores information accessible by processor 150, including instructions 140 for execution by the processor 150 and data 130 which is retrieved, manipulated or stored by the processor 150. For example, the memory 120 may store data 130 such as user information (e.g., user name, password, background information, contact information). The data 130 may also include medically important data which are derived from the use of the system, such as symptom indicators and behavioral violations. For example, the data 130 may be a predefined set of criteria, such as a collection of trigger words, which may be used to detect when a user exhibits signs of psychological distress or some type of inappropriate conduct. The instructions 140 may be executed by the processor 150 to enable communications among members of the group and to analyze those communications. If, in analyzing the communications or other data (such as position) provided by the mobile device or end-user computer, some of the predefined set criteria are met (e.g., the user is not communicating frequently enough, or is not going to work), the instructions 140 may include a routine for providing support to the user, alerting a care giver, or taking some other remedial action with respect to the user. It should be understood that the foregoing examples of data 130 and instructions 140 are merely examples of numerous potential data and instructions for performing functions on safe and secure social network. Other instructions may also be stored for registering users, forming groups, encouraging communications, evaluating users, and providing other forms of support to the users. The memory 120 may be of any type capable of storing information accessible by the processor 150, such as a hard-drive, ROM, RAM, CD-ROM, write-capable, read-only, or the like.

The instructions 140 may comprise any set of instructions to be executed directly (such as machine code) or indirectly (such as scripts) by the processor. In that regard, the terms “instructions,” “steps” and “programs” may be used interchangeably herein. The functions, methods and routines of the program in accordance with the present invention are explained in more detail below.

Data 130 may be retrieved, stored or modified by processor 150 in accordance with the instructions 140. The data may be stored as a collection of data. For instance, although the invention is not limited by any particular data structure, the data may be stored in computer registers, in a relational database as a table having a plurality of different fields and records, or as an extensible Markup Language (XML) representation. The data may also be formatted in any computer readable format such as, but not limited to, binary values, ASCII or EBCDIC (Extended Binary-Coded Decimal Interchange Code). Moreover, any information sufficient to identify the relevant data may be stored along with the data, such as descriptive text, proprietary codes, pointers, or information which is used by a function to calculate the relevant data.

Although the processor 150 and memory 120 are functionally illustrated in FIG. 1 within the same block, it will be understood by those of ordinary skill in the art that the processor 150 and memory 120 may actually comprise multiple processors and memories that may or may not be stored within the same physical housing. For example, some or all of the instructions 140 and data 130 may be stored on removable CD-ROM and others within a read-only computer chip. In addition, some or all of the instructions 140 and data 130 may be stored in a location physically remote from, yet still accessible by, the processor 150. Similarly, the processor 150 may actually comprise a collection of processors which may or may not operate in parallel.

Moreover, while this describes one embodiment of this invention, another embodiment may be based on a peer to peer architecture in which there is no central server computer and the computational and storage tasks are distributed across the set of clients 170-185.

As noted above, the server 110 may comprise additional components typically found in a computer system such as a display (e.g., an LCD screen), user input (e.g., a keyboard, mouse, game pad, touch-sensitive screen), microphone, modem (e.g., telephone or cable modem), and all of the components used for connecting these elements to one another.

Although certain embodiments of the invention operate over the Internet, other embodiments are not limited to any particular type of network. For example, the web server 110 may be a typical desktop computer or more powerful computer server or other automated system capable of communicating with other computers over wide area networks or local area networks.

Although certain advantages are obtained when information is transmitted or received as noted above, other aspects of the invention are not limited to any particular manner of transmission of information. For example, in some aspects, the information may be sent via EDI (electronic data interchange) or some other medium such as a disk, tape, CD ROM. The information may also be transmitted over a global or private network, or directly between two computer systems, such as via a dial up modem. In other aspects, the information may be transmitted in a non electronic format and manually entered into the system.

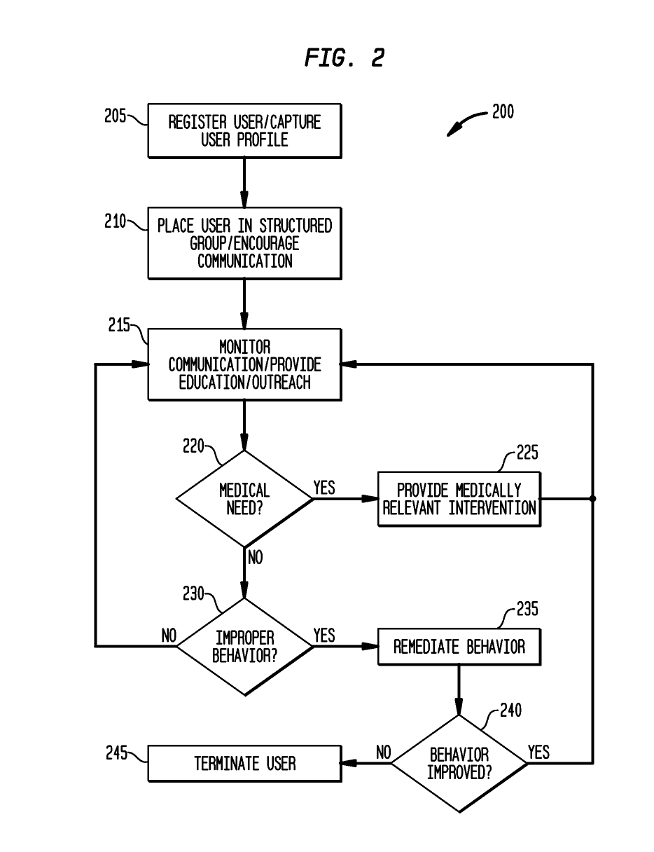

In addition to the operations illustrated in FIG. 1, an operation in accordance with a variety of aspects of a method for providing support to an individual in a community is explained with respect to FIG. 2. It should be understood that the following operations do not have to be performed in the precise order described below. Rather, various steps can be handled in a different order or simultaneously.

FIG. 2 describes a method 200 for providing support to individuals participating in a safe and secure social network for purposes of medical care. In step 205, an individual registers or is registered by an administrator or care giver on the network. Each user may be characterized by a profile containing personal information, for example, name, username, birth date, email address, etc. The individual may then, for example, create a profile page to be displayed to other users on the network.

In step 210, the individual may be linked to a specific group of other users on the network. A user may be added to a communication group that is being “constructed” by medical care giver or administrator. Alternatively or additionally, end users may be encouraged to freely discover each other guided by loose correlations of interests, background, etc. In either case, a user may belong to multiple communicating groups.

An individual may communicate freely with users in their group(s). The system and the medical care givers may interact with the users in a variety of ways including educational outreach, advising, mentoring, morale messaging, event notifications, rewards, praise, encouragement, reminders and cues, job coaching and community reintegration. Data from embedded or connected sensors may be collected from the end-user devices.

In some instances, communication among users on the network may be shaped by mentors and care givers. For example, a care giver or group mentor may post topics for discussion, hold on-line meetings, or suggest to users a particular individual to communicate with. Mentors and care givers may be provided tools to encourage social interactions between end users of the system. These tools may include prebuilt and stored collections of informational or morale boosting messages which can be sent on demand, and a capability to manage events which users would be encouraged to attend, including the ability to notify users of an event and handle user “sign-ups”. Tools may be provided to send educational messages and quizzes. Care givers would be able to track quiz results. The system may provide mechanisms to provide rewards and encouragement for accomplishments and track levels of user accomplishment.

One potential benefit of a managed, structured social network as embodied in this invention may be to facilitate monitoring the communications and other data collected from the end-user device in step 215. For example, a medical care giver, a mentor or an administrator may review the communications or perhaps the locations visited by a particular user. Alternatively or additionally, the processor 150 may analyze such communications and other data for medically important patterns, events, and criteria which are part of the system configuration. For example, the processor 150 may compare the text of such communications to a set of keywords and execute actions, such as notifying a care giver, if necessary.

One goal of these system executed analyses will be to automatically detect medically significant signals in the data collected about the user (e.g., communications with others in the group, or data derived from sensors) as such signals may indicate either mental, emotional or psychological or physical distress, or indications of inappropriate behavior. Analyses may also be performed on the stored data to provide summaries, charts, visualizations or other aids to a care giver or mentor to facilitate their work with the members of the social network.

In step 220, it is determined, based on a user's communications and other data collected from the end user device, such as position sensors, whether that user exhibits emotional or psychological distress or other medically important signs or symptoms, and whether that user could benefit from intervention. Intervention may take the form of interacting with the user either through the communication infrastructure itself or some other mechanism. For example, if a user transmits a message to their group or other user stating “I don't feel like getting out of bed anymore,” it may be determined that the user needs some type of help. Alternatively or additionally, if the system detects that a user is not going outside of the user's home for extended lengths of time it may be determined that a care giver may need to intervene. Accordingly, in step 225, some type of intervention may be taken. This may take many forms; for example, a care giver within the network may provide educational messages, a private conversation, referral to online content, assignment of a mentor or buddy to interact with the user experiencing difficulty, or increased monitoring. Alternatively or additionally, the user may be encouraged to contact a healthcare professional outside the social network such as a doctor, nurse or social worker, or to take other similar and appropriate action.

As one of the goals of the system is to provide a safe social environment, it may be determined in step 230 whether a user is exhibiting inappropriate behavior, such as using foul language, posting explicit content, harassing another user, etc. For example, a user's communications may be monitored by an administrator or automatically analyzed by the processor 150 against a predefined and configurable set of criteria. If improper behavior is detected, remedial action may be taken in step 235. Such remedial action may include, for example, transmitting a warning to the offending user or restricting the offending user's access or communication rights. According to one aspect, the offending user may be monitored more closely after inappropriate behavior is detected.

If no inappropriate behavior or medically significant events are detected, the method 200 may simply return to step 215, where users communicate freely and the user's communications are monitored regularly.

In step 240, it is determined whether the behavior of the offending user has improved. For example, if the offending user does not exhibit any inappropriate behavior for a predetermined period of time after remedial action, it may be determined that the offending user's behavior has improved. Accordingly, any access or communication restrictions imposed on the user may be lifted, and the user may be encouraged to communicate with other users. All such communications may be continually monitored as describe above in line with the principles of the system. However, it may be determined in step 240 that the offending user's behavior has not improved. For example, the offending user may continue to transmit or post offensive content detected by the administrator or processor 150. Accordingly, that offending user may be prohibited from communicating through the social network, and more radical action such as banning the user from the social network may be taken.

Though not shown in FIG. 2, according to one aspect of the invention a set of historical data may be logged for all users of the network. For example, all the communications occurring within the system may be logged as well as any sensor data collected by the end-user device. Moreover, the results of analysis of this data, performed by the processor 150 according to the algorithms stored within the system may be stored as well.

If it is detected in steps 220 or 230 that a user exhibits signs of emotional distress, need for care giver intervention, or inappropriate behavior, such information may be logged in a user's historical data file. In this regard, such information may be used and readily accessible in evaluating the need for intervention or evaluating future communications of the user.

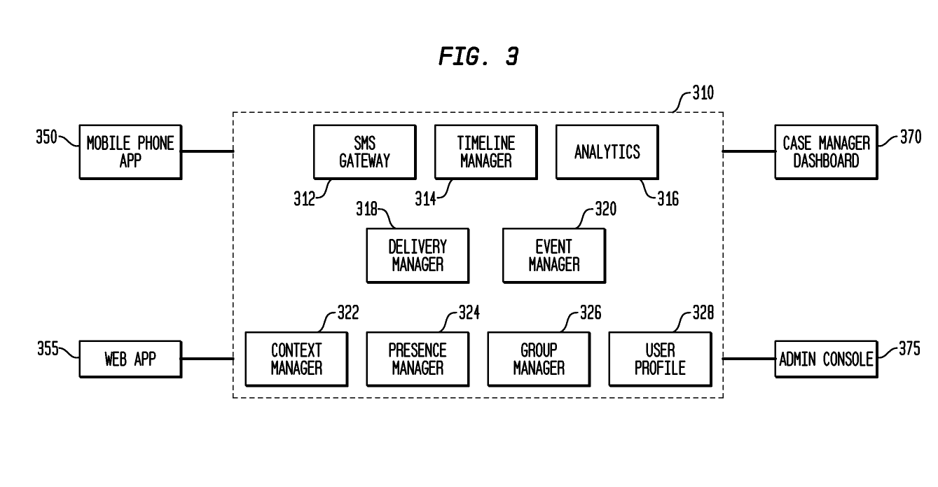

Though described generally with respect to the example above, the system and method for providing support to a community through a social network may have a number of subcomponents which help it realize its functionality. According to another aspect of the invention, the server 310 may include a number of components used to carry out the steps described above. For example, FIG. 3 provides a more detailed illustration of such components that may be found within the server 310.

Event manager unit 320 may serve as a backbone of other components in the server 310 in the sense that it manages fundamental processing building blocks of the system—system detected “events”. System detected events may be as simple as a user communication or post or a pattern of composite events such as user not communicating or going to work. The data flowing from the connected network (communication data, sensor data, etc.) may be organized into events which are processed by the event engine. A significant example of such event processing would be user communication with other users through the posting of information or communications which are presented in the public viewing space. Communications (posts) may be treated as events and processed by the event manager 320 (e.g., receiving a post from a user, determining recipients for the post, filtering posted content, etc.). In this regard, the event manager unit 320 operates in conjunction with a delivery manager unit 318 to ensure proper delivery of postings. It may also notify an administrator if, for example, offensive content is posted, and further may wait for approval from the administrator before permitting delivery of the content. The event manager unit 320 may also manage the presence of a user. For example, if a user accesses the social network via a mobile device, SMS, or the Web application, the presence manager unit 320 may determine the status of a user's presence, transmit such information to a presence manager unit 324 to determine which users should be notified, and route the information for such users to the delivery manager unit 318.

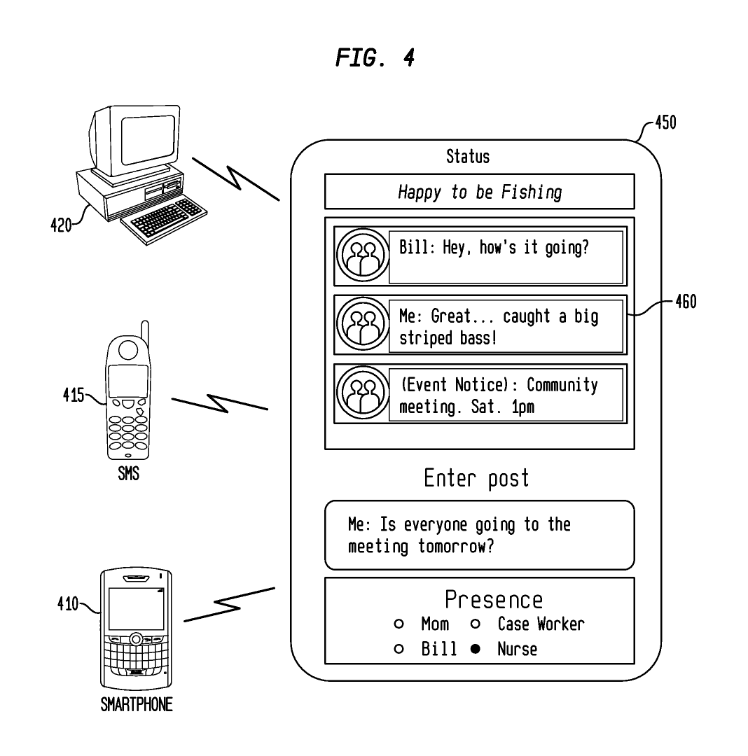

A timeline manager unit 314 may record all user posts, organized in a timeline. For example, as shown in FIG. 4, posts from various users may be listed in chronological or conversational order, and this list may include other information such as time of post, user transmitting the post, group or group member to whom message is delivered, message content, etc. The timeline manager unit 314 may also record all presence events and communications among users. According to one aspect of the invention, the timeline manager 314 may be configured to organize recorded events by group, user device or client computer, user, etc. Further, an indicator may be placed next to selected posts or communications in the timeline, such as those containing inappropriate content. Timelines may be “flat”, e.g., simply organized by time, or threaded, e.g., organized by time and topic. In general the invention may provide a variety of presentations of the posts organized in a variety of ways, based on properties of the posts, such as time, user, group, topic and other such characteristics.

A delivery manager unit 318 determines how to deliver messages to each destination. For example, messages may be delivered via SMS or wireless data transmission to a mobile device, via a generic wide area network data interface, email, etc. to or from any device. Delivery manager unit 318 may manage delivery of a communication from a central server to a mobile device in a variety of formats (e.g., SMS message, XMPP instant messaging protocol, HTTP web protocol or proprietary data transmission). Similarly, delivery to a stationary device may take a variety of forms, including web centric transmission protocols or other means. One role of the delivery manager is to determine the proper medium and format for transmission of data. Additionally, the delivery manager unit 318 may handle adjustments to messages needed for delivery. For example, it may break up a post larger than the SMS limit into several small messages, and then correlate the smaller messages. According to one aspect, the delivery manager unit 318 may also restrict posts to fit within a particular size, such as the size of an SMS.

A presence manager unit 324 manages presence status of users on the network. For example, when a user accesses the network, the presences manager unit 324 may cause a message, a symbol, or a personalized icon of the user to be displayed to other linked users to signal the availability of a user. The presence manager unit 324 may operate in conjunction with the event manager unit 320 and the delivery manager 318 to update user presence status across the network, implement presence policies (i.e., define who is able to see a user's presence), etc. Moreover, the presence manager unit 324 may ensure that an administrator (e.g., a group mentor) is available at any time particular users are present on the network to ensure that proper monitoring and support may be provided for that user.

A group manager unit 326 may define a user or group of users by some identifying indicia (e.g., group name, user name, uniquely assigned identifier, user's internet protocol address, etc.). In defining a group, the group manager unit 326 may add or remove members of the group, or assign a role to a particular user in a group (e.g., patient, mentor, moderator, case manager). Because a user may belong to multiple different groups, the group manager unit 326 may also track which groups each user belongs to.

The SMS gateway unit 312 facilitates routing of SMS posts to and from cell or mobile phones. The SMS gateway unit 312 sends SMS post to specified mobile phone destinations, for example, as directed by the delivery manager unit 318. Further, the SMS gateway unit 312 may receive SMS, such as posts, from mobile phone users and forward these messages to the event manager unit 320. As described above, communication with mobile devices may occur via means other than SMS.

Each user, or a care givers and system administrators, working on behalf of a user, may create a user profile 328. This profile may include, for example, name, picture, short biography, URL, contact information, or information concerning how the user accesses the network (e.g., whether by stationary computer, of mobile phone). The user profile may be modified by the user, or in some circumstances, by another user such as an administrator. For example, if a first user's profile identifies linked users, and one of the linked users' accounts is deleted, the identification of linked users on the first user's profile may be altered. The user profile 328 may also be used to set user preferences. For example, a messaging mode may be set to allow only SMS messages or only Instant Messages over XMPP, or to deliver only particular types of messages at certain times throughout the day.

An analytics unit 316 may create a summary for each user or for all the members of a group. The summary may, for example, utilize a color-coded system to indicate a level (e.g., frequent, occasional, etc.) of the user interacting within the network. Such a system of presentation utilizing color-codes or other summary indicators may be defined by any of a wide range of criteria, and may be modified by an administrator to more accurately designate the level of users' interactions or other results of an analysis of a user's data. The analytics unit 316 may also provide a mechanism for an administrator to obtain more detail on social interactions among particular users, such as by providing statistics on how frequently a user is present on the network, how often that user communicates with other users, and the like.

Context manager 322 may operate in conjunction with the analytics unit 316 to evaluate the data about users to establish a “context” for them, e.g., at home, at work, at lunch, needing exercise, etc. The context manager 322 may “fuse” data from a variety of sources and apply algorithms to compute user contexts. For example, data from position sensors can be combined with geospatial data along with schedule data to assess whether a user is where they need to be or is someplace unexpected. The context manager 322 is capable of recognizing complex patterns in the stream of events which may be used to guide the medically motivated interaction of the system with individual users.

The social network may be accessed by one or more user devices or client computers. Such user devices or client computers have been described generally above as being used by either end users, care givers or administrators. Access to the system may be provided through a variety of devices, including mobile phones or other portable devices or via stationary computing devices such as desktop computers. Accordingly, such devices may be equipped with a mobile phone application 350 or through Internet or “Web” application 355.

Both the web application 355 and the mobile phone application 350 may provide the user with a display of the timelines for individual users and groups that a user participates in. By these applications a user may read messages in a timeline, display presence for social group members, or register/unregister the user's presence either explicitly by user action or implicitly by application.

Administrators, mentors and care givers may access the social network using the case manager dashboard 370. The case manager dashboard 370 may present a color-coded (red/orange/green) social networking rating for each user. For example, a user may be associated with a red code if that user exhibits signs of a psychological distress, while another user may be associated with a green code if that user is participating appropriately in the network. The case manager dashboard 370 may also provide the administrator with a report of users' social network interactions, categorized or summarized by frequency (e.g., daily, weekly, or monthly interactions), type (e.g., posts submitted, direct posts received, calls initiated), or the like. Sensor data and computed context may also be used as sources of data which may be summarized in the case manager dashboard. The case manager dashboard 370 may also provide the administrator with statistics for presence and communication of social group members.

The administrator console application 375 provides an interface which is designed to support the tasks of administrators such as configuration and maintenance of the system. Through this interface an administrator may oversee the functioning of the components described herein and make adjustments to improve their functioning. Additionally, this interface may be used troubleshoot problems, or to resolve configuration issues. Maintenance operations, such as backup and security management may be carried out through this interface.

According to one aspect of the invention, the users may be patients (people under medical care), care givers (either lay or professional), group members, or administrators. Patients may be people with special needs or users for which monitoring is more focused, such as members of military deployed overseas or people recovering from a catastrophic illness. Group members may be supporters of the patient, such as friends, family members, and other members of a community. It should be understood that a group within the social network may include more than one patient, or may be entirely composed of patients who, while needing support themselves, also support each other. Alternatively, a group might consist entirely of care givers, such as the spouses of those who have suffered a catastrophic illness. Groups may mix different types of users (e.g., patients, mentors, care givers) or be purely of one type (e.g., lay care givers). Any given end user may belong to multiple groups.

Patients may access the social network to interact with a social group, either directly or by viewing the group's message history (timeline). The patient may view which other group member are accessing the network at a particular time using the presence indicator. Accordingly, the patient may contact those group members via submitting a post or via initiating a voice interaction via, for instance, a phone call or VoIP session. Further, patients may participate in other functions that may be provided by the system such as educational outreach, advising, mentoring, morale messaging, event notifications, rewards, praise, encouragement, reminders and cues, job coaching and community reintegration.

Care givers may access the social network to communicate with and provide support to patients and other care givers. Similar to patients, care givers may communicate directly with other or with an entire group by submitting posts, initiating phone calls or other voice based interactions, or by simply viewing a group's timeline. According to one aspect, communication policies may be defined to determine whether a care giver's presence may be indicated to others or whether that care giver may be contacted by others. According to another aspect, care givers may receive some type of notification when it is determined that a patient needs support. For example, if a monitored patient's communication triggers a flag indicating that the patient is exhibiting emotional distress, one or more of that patient's care givers may be encouraged to communicate with that patient.

Administrators, though described generally above, may be group moderators, group organizers, or case managers. In some circumstances, responsibilities of group moderators, group organizer, case managers, or other administrators may overlap. Similarly, it should be understood that in some circumstances, one person may perform several administrative roles, such as by serving as a group moderator and a case manager at the same time.

A moderator may be a member of group who is designated to facilitate conversation among patients and care givers. For example, if communication ceases for a predetermined period of time despite presence of more than one user, the moderator may post a question or topic for comment by the other care givers. Additionally, if a group's discussion begins to depart from a specific topic, the moderator may assist in refocusing the conversation. In moderating the conversation, the moderator may also try to shape the conversation into one that is positive and provides support to one or more patients. The moderator may also monitor user posts for offensive or inappropriate content. This process may be partially automated by the server 310, which could look for specific words or simple patterns in posts and notifies the moderator. More sophisticated analyses of communication and sensor data may be provided. The moderator may also have the authority to delete particular posts from a timeline if they include inappropriate content, to approve posts submitted by group members before they are displayed in the timeline, or to block a particular user from submitting posts for a period of time if that user continues to submit inappropriate content.

A group organizer may facilitate the structuring of groups within the social network and may help to manage those groups. For example, the group organizer may admit users to a group, designate users as either patients or members or administrators, and encourage users to submit complete information about themselves (e.g., name, picture, brief biography, contact information, contact preferences). The group organizer may also update user information as such information changes over time, and may update group information, such as by adding or deleting users or changing a user's role.

A case manager may assess the effectiveness of a group within a social network, and particularly may assess the benefit to a patient of belonging to the group. For example, the case manager may assess patient's interactions with their group members, view summarized reports of patients' communications (e.g., as measured by frequency of posts, calls, etc.), view details of a patient's social network interaction, and designate a patients level of need (e.g., red, yellow, green). The case manager may also evaluate moderators' communications with their groups, and may assist in encouraging communication and providing support to patients. In this regard, the case manager may be a therapist or mental health professional. While other users may be involved in extended system functions, the case manager may be the primary administrator and supervisor of functions such as educational outreach, advising, mentoring, morale messaging, event notifications, job coaching and community reintegration

FIG. 4 provides a screen shot illustrating various user controlled devices interacting on the social network. For example, users may post content via a PDA 410 using the mobile phone application 350. Users may also access the network using a less sophisticated mobile phone 415, and may communicate with the network via SMS text. Also, users may access the network using a PC 420 running the Web application 355. In each circumstance, the information is provided on a display 450 for view by the user and other selected users in a timeline 460.

The foregoing invention provides many useful features, including access to the system at many times and in many situations in the spirit of many support and “hot lines”. That is, because the social network is accessible by mobile phone, it is available to the user as desired. Thus, when a user needs support, the user may simply access the social network to reach a community of people. Further, the presence manager unit 324 may indicate to the user who is available to provide support at that time. Thus, merely knowing that another group member is available on the network may provide a sense of security, acceptance, and support to a patient. Another beneficial feature of the present invention is that it enables users to express themselves leveraging the developing social networking paradiyms, such as diary (blogging) or conversational semantics (chat). Even further, it enables a user's support group to be managed to determine who is in the group and whether any group member is abusing the application or exhibiting inappropriate behavior—and this capability can be supported through sophisticated analysis of data from a variety of sources, including connected sensing devices or by computing a user context.

Although the invention herein has been described with reference to particular embodiments, it is to be understood that these embodiments are merely illustrative of the principles and applications of the present invention. For example, while the invention has been described with respect to members of the armed forces desiring support, it should be understood that the present invention may also be applied to various types of patients requiring any of a number of different forms of care (e.g., recovering alcohol abusers or drug users, patients recovering from a traumatic event, patients on a weight-loss regimen, etc.). It is therefore to be understood that numerous modifications may be made to the illustrative embodiments and that other arrangements may be devised without departing from the spirit and scope of the present invention as defined by the appended claims.

1. A method for providing support to individuals in a community, comprising:
providing an interface for users to register on a network;
receiving data transmitted through the network, the data including communications among users and sensor information;
storing at a storage unit a first set of predefined criteria for detecting a need to medically intervene with at least one user;
analyzing at a processor the received data in comparison to the first set of predefined criteria to determine if the at least one user requires medical intervention; and
communicating information to the at least one user based on the analysis.

2. The method according to claim 1, further comprising:
storing at the storage unit additional data, including at least one of educational material and social events available for the user to participate in; and
transmitting the additional data to the user.

3. The method of claim 1, further comprising:
storing at the storage unit accomplishments of the user; and
analyzing at the processor the accomplishments in combination with the received data.

4. The method of claim 3, further comprising transmitting to care givers results of the analyzing at the processor the accomplishments in combination with the received data to facilitate medical intervention.

5. The method according to claim 1, wherein the step of communicating information to the at least one user comprises providing medical care to the user.

6. The method according to claim 5, wherein the medical care includes communicating information from at least one of a professional care giver and a peer.

7. The method according to claim 1, wherein the step of communicating information comprises transmitting a request to other individuals to interact with the at least one user.

8. The method according to claim 1, wherein the step of communicating information includes providing praise or encouragement, or awarding points or virtual rewards.

9. The method according to claim 1, wherein the step of communicating information comprises indicating to the at least one user which other individuals in the network are accessing the network at a particular time.

10. The method according to claim 1, further comprising storing user history data obtained from the analyzing step.

11. The method according to claim 10, further comprising analyzing the user history data at the processor in connection with determining if the user requires medical intervention.

12. The method according to claim 1, further comprising:
storing at the storage unit a second set of predefined criteria for indicating inappropriate behavior;
analyzing the received data at the processor in comparison to the second set of predefined criteria to determine if the at least one user is transmitting data with inappropriate content; and
taking remedial action with respect to the at least one user.

13. The method according to claim 12, wherein the step of taking remedial action includes restricting the user's transmission or receipt of data.

14. The method according to claim 12, wherein the step of taking remedial action includes removing the user from the network.

15. A system for providing support to individuals in a community, comprising:
a server configured to communicate with at least one user client computer and at least one administrative client computer;
a storage medium storing predefined criteria indicating medical need;
a processor configured to analyze information communicated through the at least one user client computer in connection with predefined criteria, and to notify the at least one other client computer if the information meets the predefined criteria.

16. The system according to claim 15, wherein the storage medium further stores user history data related to analyses performed by the processor, and wherein the processor is configured to analyze the user history data in connection with analyzing information communicated through the at least one user client computer in connection with predefined criteria.

17. The system according to claim 15, wherein the processor is configured to receive sensor data from at least one sensor and analyze the sensor data in connection with predefined criteria, and to notify the at least one other client computer if the sensor data meets the predefined criteria.

18. The system according to claim 17, wherein the analyzed sensor data is stored in the storage medium as sensor history data, and wherein the processor is configured to analyze the sensor history data in connection with analyzing other information communicated through the network.

19. The system according to claim 15, further comprising a unit for enabling data in a first format to be converted to data of a second format for transmission between different types of devices.

20. The system according to claim 15, further comprising a unit for organizing communications from and to the at least one user client computer.

21. The system according to claim 20, wherein the communications may be organized by time of transmission, time of receipt, sender, recipient, or subject matter.

22. The system according to claim 15, wherein the storage medium stores a second set of predefined criteria for indicating inappropriate behavior, and wherein the processor is further configured to analyze information communicated through the at least one user client computer in connection with second set of predefined criteria.

23. The system according to claim 16, wherein the user history data includes events, invitations, responses and attendance records for the users.

24. The system according to claim 17, wherein the storage medium stores at least one of educational, job coaching, and community reintegration materials; and
wherein the materials are transmitted to the at least one client computer or the at least one other client computer in response to determining that the analyzed information meets the predefined criteria.

25. A computer readable medium storing a program executable on a computing device, the program comprising data and instructions for:
providing an interface for users to create and display a user profile;
enabling the users to transmit and receive data to and from other individuals;
enabling the reception of sensor data from connected devices
storing at a storage unit a first set of predefined criteria for indicating medical need;
analyzing at a processor the data transmitted by the user and the sensor data in comparison to the first set of predefined criteria to determine if the user exhibits medical need; and
communicating with the user based on the analysis.
